(19) United States
(12) Patent Application Publication
(10) Pub. No.: US 2024/0149558 A1
(43) Pub. Date: May 9, 2024

(54) Hempcrete Wallboard Panel

(71) Applicant: Armani Bradford Azir Galeed, Delray Beach, FL (US)

(72) Inventor: Armani Bradford Azir Galeed, Delray Beach, FL (US)

(21) Appl. No.: 17/824,933

(22) Filed: May 26, 2022

(51) Int. Cl. B32B 13/08; B32B 7/12

(52) U.S. Cl. CPC B32B 13/08; B32B 7/12; B32B 2038/0076; B32B 2607/00

(57) ABSTRACT

Embodiments relates to an enhanced assembly for interior construction using wallboard mainly composed of Hempcrete unit which primarily reduces the carbon footprint associated with prior methods. The hempcrete wallboards may be affixed, joined, abutted, fashioned, finished and painted in the way common to all those skilled in the art.

### CROSS-REFERENCE TO RELATED PATENT APPLICATION

This application is a continuation in part of prior filed application entitled “Hempcrete Wallboard Panel” of Armani-Bradford Galeed, the sole owner and inventor of this application, Ser. No. 17/824,933, filed May 22, 2022, which is incorporated by reference herein in its entirety.

### BACKGROUND

### Field of the Invention

The present invention relates in general to wallboard panels as articles of manufacture and more particularly relates to the manufacturing of a wallboard intended for interior construction purposes only, the main component of which is Hempcrete.

### Description of the Related Art

The advent of gypsum wallboards (Sackett Board) and its progression from the early 20th century is well documented in prior art. Today's wallboard panels consist primarily of a single layer of gypsum between two sheets of corresponding paper, with beveled edges and differing dimensions. Gypsum wallboard panels as customarily manufactured are of elongate rectangular formation. A slab of gypsum plaster composition is wrapped in heavy paper sheeting while the slab is still wet, resulting in close adherence of the sheeting to the slab and, after setting and hardening of the plaster, in a relatively strong and flexible building panel for use in place of plaster applied Wet on the job.

At the ends of such a gypsum wallboard panel, the slab is usually not covered, but the paper sheeting does extend around and cover the longitudinal edge faces of the slab, which intersect both broad panel surfaces or faces of the slab perpendicularly. As so formed, difficulties have been experienced both in the handling of the panels and in their use in building construction.

Furthermore, it is generally known to construct buildings in a modular fashion from a number of panels fixed together. However, there are a number of problems associated with such panels. Many panels are made from non-environmentally friendly materials and/or have poor thermal characteristics. Modern building regulations are placing stricter requirements on the thermal characteristics of new buildings or modifications to older buildings. There are similar concerns regarding the carbon footprint of materials used in construction. However, at the same time, construction panels need structural strength and need to be capable of supporting the weight of panels above them as well as the weight of intermediate floor structures and/or roofs.

There are multiple solutions that have been presented in prior art regarding bringing advancements in similar field. However, these solutions are limited and restricted to their conventional preparations and are not feasible weight of construction panels, cost and multiple scenarios uses. Moreover, the current solutions that exist in the marketplace today, have been considered as non-environmentally friendly materials and/or have poor thermal characteristics.

Thus, the conventional solutions do not present an effective methodology in production of lightweight structural units such as wallboard panels units. The current invention proposes a novel approach to wallboard panel constitution, wherein the primary components of current wallboards are comprised mainly of gypsum an inorganic carbon weak material, the invention presented herein is comprised primarily of mechanically pressed hempcrete which is a carbon negative (sequestering) material especially when non hydraulic lime is utilized as the binding agent.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of wallboards intended for interior construction purposes only with main component of which is Hempcrete

The main objective of the invention is to provide a remedy which poses improvement by having an improved methodology by presenting environment friendly materials with better thermal characteristics.

It is further the objective of the invention to provide a methodology where hempcrete wallboards may be affixed, joined, abutted, fashioned, finished and painted in the way common to all those skilled in the art.

It is also the objective of the invention to provide design which is for a multi-segment construction block that interlocks laterally and vertically, does not require mortar and is self-aligning.

It is moreover the objective of the invention to provide a smart method which is cost effective and is long term cost effective.

Thus, it is the objective to provide a new and improved solution for effective Hempcrete Wallboard Panel. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BREIF DESCRIPTION OF DRAWINGS

FIG. 1 discloses a top view as per illustrative embodiments of the invention.

FIG. 2 discloses the detailed view as per illustrative embodiments of the invention.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide an effective methodology for Hempcrete Wallboard Panel, which is comprised primarily of mechanically pressed hempcrete which is a carbon negative (sequestering) material especially when non hydraulic lime is utilized as the binding agent.

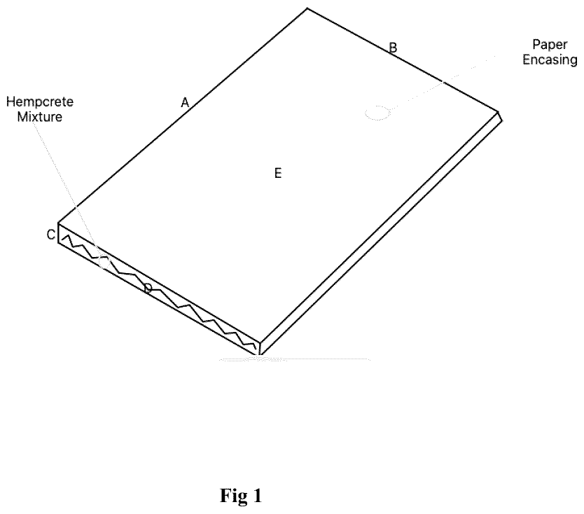

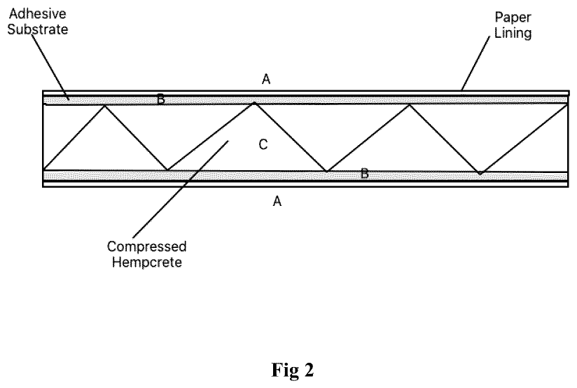

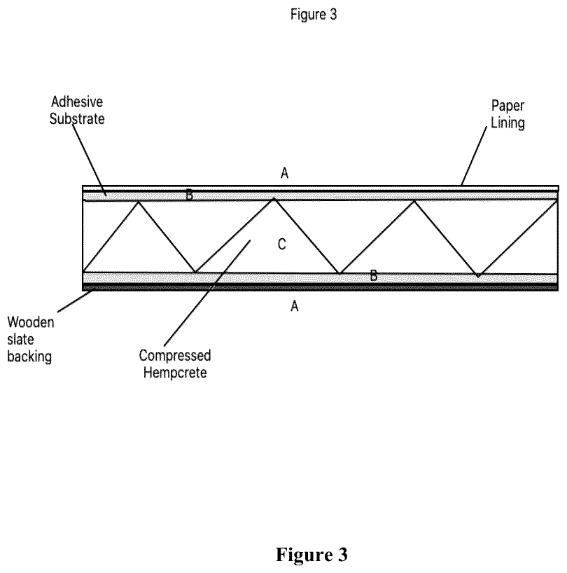

As shown the FIG. 1 show a top view and FIG. 2 shows a detailed look at the layering of the proposed method. FIG. 1 displays a four-foot (A.) by eight-foot (B.) by 22 mm (C.) panel of hempcrete wallboard. The board is composed of a central core of pressed hempcrete (D.) surmounted on both sides by a thin layer of papered coating (E.).

FIG. 2 displays an enhanced view of the layering schematics of the proposed invention. One single layer of Paper (A) on each of the vertical faces adjoined to a layer of Adhesive Substrate (B) which serves two purposes; to affix the paper coating to the central core and to ensure a smooth surface on the face of the compressed hempcrete core (C).

FIG. 3 displays an enhanced view of the layering schematics of the proposed invention. One single layer of Paper (A) on each of the vertical faces adjoined to a layer of Adhesive Substrate (B) which serves two purposes; to affix the paper coating to the central core and to ensure a smooth surface on the face of the compressed hempcrete core (C). One single layer of wooden backing allowing for reinforced form and greater strength adhesion when being installed.

A Hempcrete Wallboard is the first wallboard composed of a hempcrete central core, to be utilized within the construction of the interior of a dwelling.

A process of composing an Hempcrete Wallboard with two adhesive substrates for the purpose of providing a smooth surface and paper layering on each of the vertical faces along with beveled edges.

The manufacturing of the proposed invention is to be performed thus; an admixture of the stalk of the Cannabis sativa plant, a binder such as non-hydraulic and/or hydraulic lime and water are to be mixed until the desired consistency is achieved. This mixture is then spread onto various plates where it will undergo a drying process, prior to the full drying process is completed the admixture is to be mechanically pressed to present the greatest density possible. The admixture will then be given the appropriate time to fully cure. Once a complete curing has taken place the admixture now in slate form will be given an adhesive coating to ensure that the surface is smooth. Once the adhesive coating has been added a layer of paper will be applied to each vertical side, the hempcrete wallboards will then undergo the beveling process of their respective edges, stacked and prepared for shipping.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A wallboard panel comprising mainly of hempcrete where:
1. wall board as per claim 1, has central core of pressed hempcrete;
2. wall board as per claim 1, is surmounted on both sides by a thin layer of papered coating;

2. The single layer of Paper on each of the vertical faces adjoined to a layer of Adhesive Substrate which serves two purposes including:
4. wall board as per claim 2, allows to affix the paper coating to the central core;
5. wall board as per claim 2, to ensure a smooth surface on the face of the compressed hempcrete core.

3. A manufacturing process of hempcrete wallboard including:
A hempcrete wallboard as per claim 3, involves an admixture of the stalk of the Cannabis sativa plant;
A hempcrete wallboard as per claim 3, involves a binder such as non-hydraulic and/or hydraulic lime;
A hempcrete wallboard as per claim 3, involves water are to be mixed until the desired consistency is achieved;
A hempcrete wallboard as per claim 3, involves spreading the mixture onto various plates where it will undergo a drying process;
A hempcrete wallboard as per claim 3, involves mechanically pressing the admixture before full drying for highest density;
A hempcrete wallboard as per claim 3, allowing the admixture to be cured in preset timeline;
A hempcrete wallboard as per claim 3, involves giving the admixture an adhesive coating to ensure smoothness;
A hempcrete wallboard as per claim 3, involves adding a layer of paper to each vertical side;
A hempcrete wallboard as per claim 3, involves the hempcrete wallboards to undergo the beveling process of their respective edges, and;
A hempcrete wallboard as per claim 3, involves the stacking and preparing for shipping.
